(19) United States
(12) Patent Application Publication
(10) Pub. No.: US 2012/0162994 A1
(43) Pub. Date: Jun. 28, 2012

(54) Light Fixture Assembly

(76) Inventors: Cory Wasniewski, Oak Creek, WI (US); Kyle N. Mahan, Johnson Creek, WI (US)

(21) Appl. No.: 12/976,098

(22) Filed: Dec. 22, 2010

(51) Int. Cl. F21V 29/00

(52) U.S. Cl. 362/294

(57) ABSTRACT

A housing for a recessed light fixture for installation into a passenger compartment of a vehicle includes a composite trim assembly. The composite trim assembly includes a spacer and a trim member. The spacer operably engages the housing of the light fixture and the trim member is connected to the spacer. The spacer aligns the trim member with the housing such that the trim member does not contact the housing. Consequently, the trim member, which is exposed to the passenger compartment upon installation, maintains a lower temperature than the housing to which it is connected.

### BACKGROUND OF THE INVENTION

1. Field of the Invention

The subject matter disclosed herein relates to a housing assembly for a recessed light. More specifically, a recessed housing for a light emitting diode (LED) light source used in a passenger cabin of a vehicle is disclosed.

2. Discussion of the Related Art

Conventional lighting systems for the passenger cabin of a vehicle, for example an airplane, are well known. Historically, these lighting systems have utilized fluorescent light to illuminate the cabin. However, fluorescent light fixtures require sufficient space to house the bulbs and the ballast required to regulate current through the bulbs. Further, the light fixture requires a certain amount of power to illuminate the bulb. Because vehicles, such as airplanes, have limited cabin space and a finite amount of power supplied by the on-board electrical system, it is desirable to provide lighting fixtures of smaller size with improved energy efficiency.

Advances in LEDs have resulted in light fixtures that utilize LEDs as the light source. LEDs utilize less energy to generate light intensity comparable to that of a fluorescent bulb. Further, LEDs require less space than fluorescent bulbs, resulting in light fixtures having a smaller size with improved energy efficiency that are capable of producing similar quantities of light.

However, LEDs and the electronic circuits used to control them generate significant heat. The housing of such a light fixture, therefore, is typically designed to transfer the heat away from the housing. Consequently, the housing, including portions extending into the passenger cabin, can become warm or even hot to the touch. Because the height of a ceiling in a passenger cabin, for example on an aircraft, is typically not much greater than the average height of a passenger, and areas of the cabin, for example, with storage compartments over seats may further reduce the height of the ceiling, the potential exists for a passenger to contact the housing of the light fixture. Thus, it would be desirable to provide a housing for a recessed light source for use in a passenger cabin that dissipates heat generated by the light source without increasing the temperature on the cover of the housing within the passenger cabin.

### BRIEF DESCRIPTION OF THE INVENTION

The subject matter disclosed herein describes a housing for a recessed light fixture installed into a passenger compartment of a vehicle having a composite trim assembly. The composite trim assembly includes a spacer and a trim member. The spacer operably engages the housing of the light fixture and the trim member is connected to the spacer. The spacer aligns the trim member with the housing such that the trim member does not contact the housing. Consequently, the trim member, which is exposed to the passenger compartment upon installation, maintains a lower temperature than the housing to which it is connected.

In one embodiment of the present invention, a light fixture includes a housing configured to accept a light source. The housing has a front surface with an outer periphery and an opening extending through the front surface. The opening defines an inner periphery of the front surface, and a spacer engages the opening in the housing. A trim member is connected to the spacer and substantially covers the spacer and the front surface of the housing. The spacer retains the trim member in alignment with the housing such that a gap is maintained between the trim member and the housing. A side wall has an inner surface extending into the housing from the opening in the front surface. A portion of the inner surface proximate to the opening is threaded, and an outer surface of the spacer is complementarily threaded to engage the inner surface of the housing. Optionally, the portion of the inner surface proximate to the opening has a first member of any other suitable mechanical connector and the outer surface of the spacer has a second member of the mechanical connector. The first and second members are complementary to positively retain the spacer within the opening.

According to another aspect of the invention, the spacer further includes a generally planar rear surface, a generally planar inner surface joined to the rear surface by a beveled edge, and a lip extending radially inward. The light fixture further includes a reflective member having an opening in the rear portion to receive light radiated by the light source. The front edge of the reflective member is configured to engage the lip of the spacer.

As yet another aspect of the invention, the spacer is rigidly connected to the trim member. The trim member may include a front wall, an outer wall extending rearward from the front wall to substantially enclose an outer periphery of the flange, and an inner wall extending rearward from the front wall toward the opening defined in the front surface of the housing. The spacer further aligns the trim member with the housing such that a gap is maintained between the outer wall of the trim member and the outer periphery of the flange. The light fixture may further include a lens wherein the inner wall defines a seat for the lens.

As a further aspect of the invention, the light fixture may also include a plurality of internally threaded fasteners mounted to a rear surface of the trim member, and a plurality of openings extending through the spacer. Each opening corresponds to one of the threaded fasteners. An externally threaded fastener extends through each of the openings to operably engage one of the internally threaded fasteners and to positively retain the spacer to the trim member. Optionally, the trim member may be secured to the spacer by a suitable adhesive such as epoxy or glue.

As still another aspect of the invention, the spacer may be made of a thermally insulating material and the housing may be made of a thermally conductive material. A plurality of fins configured to conduct heat from the housing may also be included on an outer surface of the housing.

According to another embodiment of the invention, a recessed light fixture includes a housing configured to accept a light source. The housing has a rear wall, at least one side wall extending from the rear wall to a front surface of the housing, and a flange. The side wall defines an opening in the front surface of the housing, and the flange extends radially outward from an outer periphery of the side wall. A rear surface of the flange is configured to engage a front side of a mounting surface, and a mounting tab is configured to engage a rear side of the mounting surface. A spacer is connected to the side wall and proximate to the opening in the front surface of the housing. A trim member is connected to the spacer and substantially covers the spacer and the flange. The spacer aligns the trim member with respect to the housing such that a space is maintained between the trim member and the housing.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWING(S)

Various exemplary embodiments of the subject matter disclosed herein are illustrated in the accompanying drawings in which like reference numerals represent like parts throughout, and in which:

FIG. 1 is a perspective view of a light fixture according to one embodiment of the present invention;

FIG. 2 is a partial cross-sectional view of the light fixture of FIG. 1;

FIG. 3 is a perspective view of the housing utilized in the light fixture of FIG. 1;

FIG. 4 is a front plan view of the housing of FIG. 3;

FIG. 5 is a side elevation view of the light fixture of FIG. 1 engaging a mounting surface;

FIG. 6 is a perspective view of a spacer and a cover utilized in the light fixture of FIG. 1;

FIG. 7 is a side elevation of the spacer of FIG. 3;

FIG. 8 is a front plan view of the spacer of FIG. 3;

FIG. 9 is a rear plan view of the spacer of FIG. 3;

FIG. 10 is a side elevation of the cover of FIG. 3;

FIG. 11 is a front plan view of the cover of FIG. 3; and

FIG. 12 is a rear plan view of the cover of FIG. 3.

In describing the preferred embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION OF THE PREFERRED EMBODIMENTS

The various features and advantageous details of the subject matter disclosed herein are explained more fully with reference to the non-limiting embodiments described in detail in the following description.

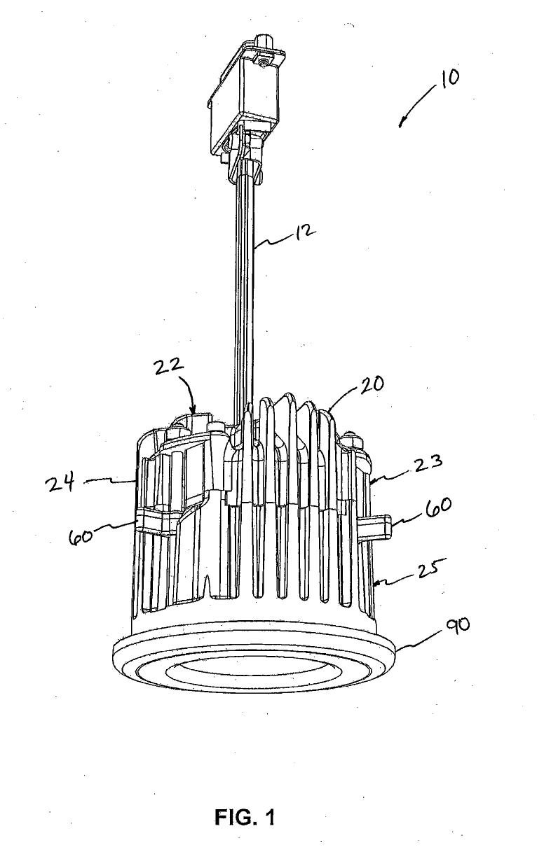

Turning initially to FIG. 1, a light fixture 10 according to one embodiment of the present invention includes a cable 12 for connecting to a network. The network may be either a standard network or a dedicated network for communication between a system controller (not shown) and individual light fixtures 10. Commands for controlling illumination of the light fixture 10, including but not limited to, the color or the brightness of the light fixture 10 may be transmitted over the network.

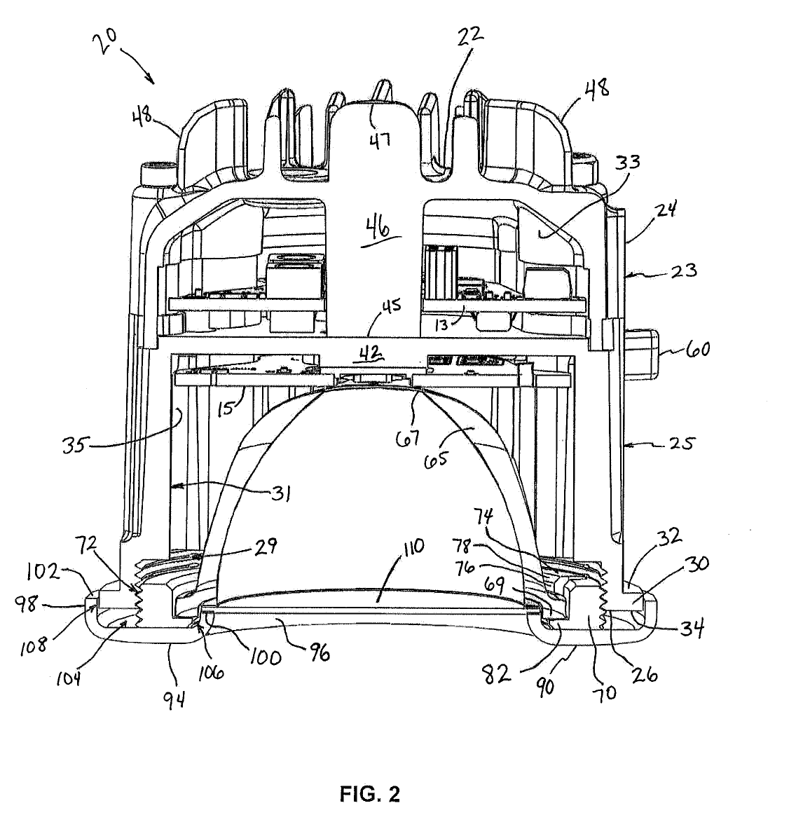

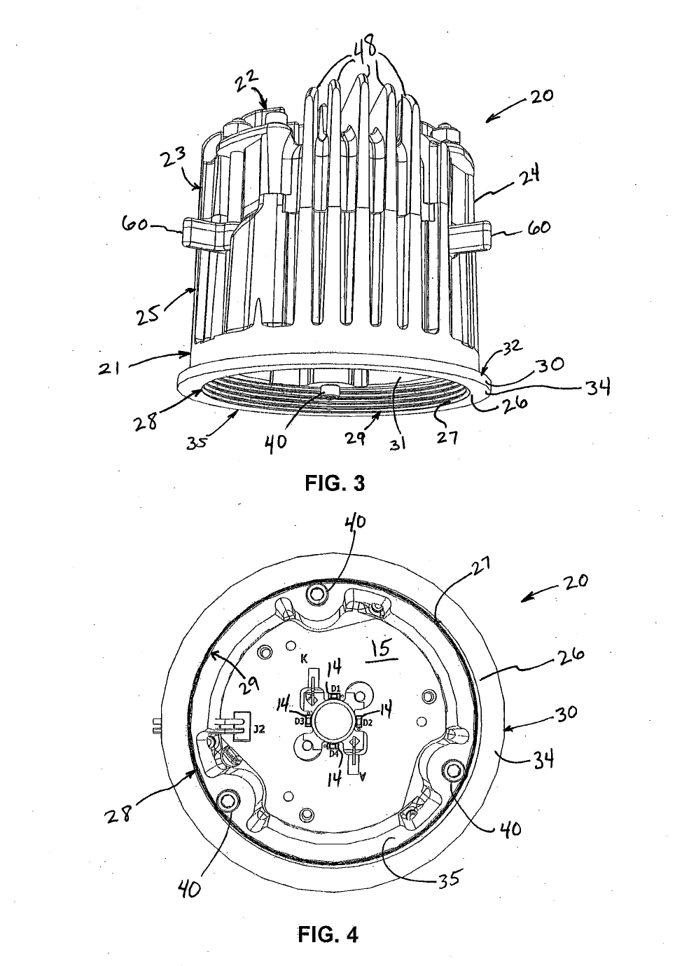

The light fixture 10 further includes a housing 20 having a rear wall 22 and at least one side wall 24 extending from the rear wall 22 to a front surface 26, shown in FIG. 2, of the housing 20. The side wall 24 may be a single wall forming a generally cylindrical housing or, alternately, may include multiple side walls 24 joined at corners to form any desired shape. The side wall 24 defines an opening 28 extending through the front surface 26 of the housing 20. The housing 20 may include a first member 23 and a second member 25. It is further contemplated that the housing 20 may be formed from a single member or from additional members without deviating from the scope of the invention.

Referring also to FIGS. 2 and 5, the light fixture 10 is configured to be mounted in a recessed manner through an opening in a mounting surface 50. A flange 30 extends radially from the outer periphery of the side wall 24 proximate to the front surface 26 of the housing 20. A front surface 34 of the flange 30 is preferably coplanar with the front surface 26 of the housing 20. Optionally, the front surface 34 of the flange 30 may be displaced along the side wall 24 from the front surface 26 of the housing 20. A rear surface 32 of the flange 30 is generally parallel to the front surface 34 and displaced along the side wall 24 from the front surface 26 of the housing 20. The rear surface 32 of the flange is configured to engage a front side 56 of the mounting surface 50.

The housing 20 further includes at least one mounting tab 60 positioned along the side wall 24. In one embodiment of the invention, three mounting tabs 60 are positioned around the periphery of the housing 20. Each mounting tab 60 includes an opening extending through the tab having a threaded interior surface. A threaded member 40, such as a bolt, is captive within the side wall 24 of the housing 20 and extends through the opening in the mounting tab 60. The threaded member 40 is rotatable to turn the mounting tab 60 between a retracted position, generally adjacent to the housing 20, and an extended position, generally perpendicular to the housing. The threaded member 40 further drives the mounting tab 60 along the side wall 24 of the housing 20 between a first position toward the rear of the housing 20 and a second position, in which the mounting tab 60 is configured to engage a rear side 54 of the mounting surface 50.

The light fixture 10 further includes a second printed circuit board 15 on which light-emitting diodes (LEDs) 14 may be mounted. A first printed circuit board 13 may include electrical circuitry to control the LEDs 14, including but not limited to a processor, memory, communication drivers, and power regulating circuits. The first and second circuit boards, 13 and 15 respectively, are electrically connected to provide one or more of the following: control signals, feedback signals, and power signals between the two circuit boards, 13 and 15, as required by the application. It is contemplated that the electrical circuits may be distributed in varying configurations between the first and second circuit board, 13 and 15 respectively, or, optionally, a portion of the electrical circuits may be contained external from the housing 20 or in another enclosure (not shown) separate from the housing 20.

The housing 20 includes a first cavity 33 defined, at least in part, by the interior of the first member 23 and a second cavity 35 defined, at least in part, by the interior of the second member 25. In one embodiment of the invention, the second circuit board 15 is mounted to a rear surface 42 of the second member 25 within the second cavity 35. The LEDs 14 are generally positioned near the center of the rear surface 42 and within the second cavity 35. An opening 44 extending through the first circuit board 13 is configured to receive a heat tube 46. The heat tube 46 may be a hollow or solid metal member. A first end 45 of the heat tube 46 is in communication with the rear surface 42 of the second member 25 and a second end 47 of the heat tube 46 extends to the rear wall 22 of the housing. The first end 45 of the heat tube 46 is generally aligned with the LEDs 14 mounted to the second circuit board 15. A thermal conduction path is thereby established from the LEDs 14 through the second circuit board 15, the rear surface 42 of the second member 25, and the heat tube 46 to the environment exterior to the housing 20. The housing 20 may additionally include a plurality of heat fins 48 extending away from the housing 20 to further facilitate the transfer of heat generated within the housing 20 to the environment exterior to the housing 20.

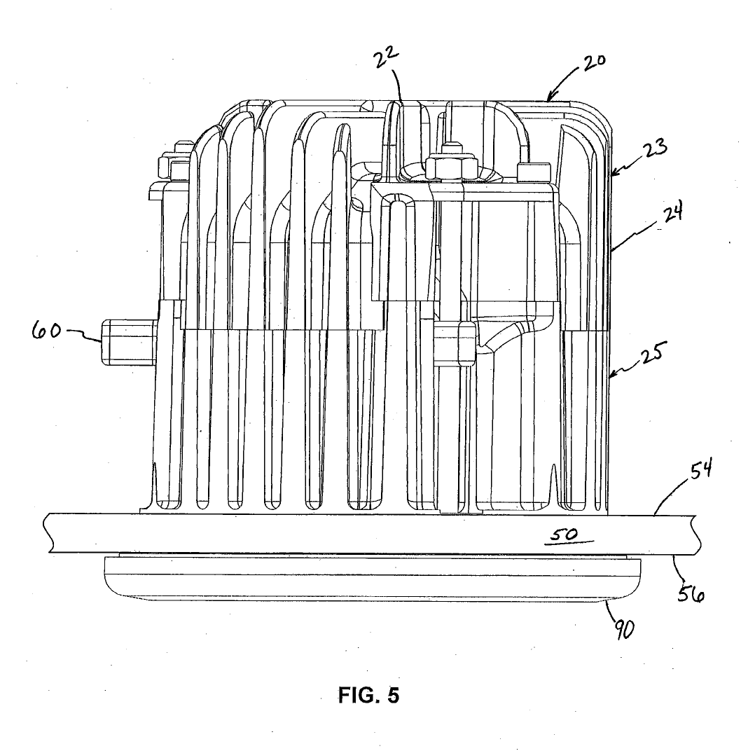

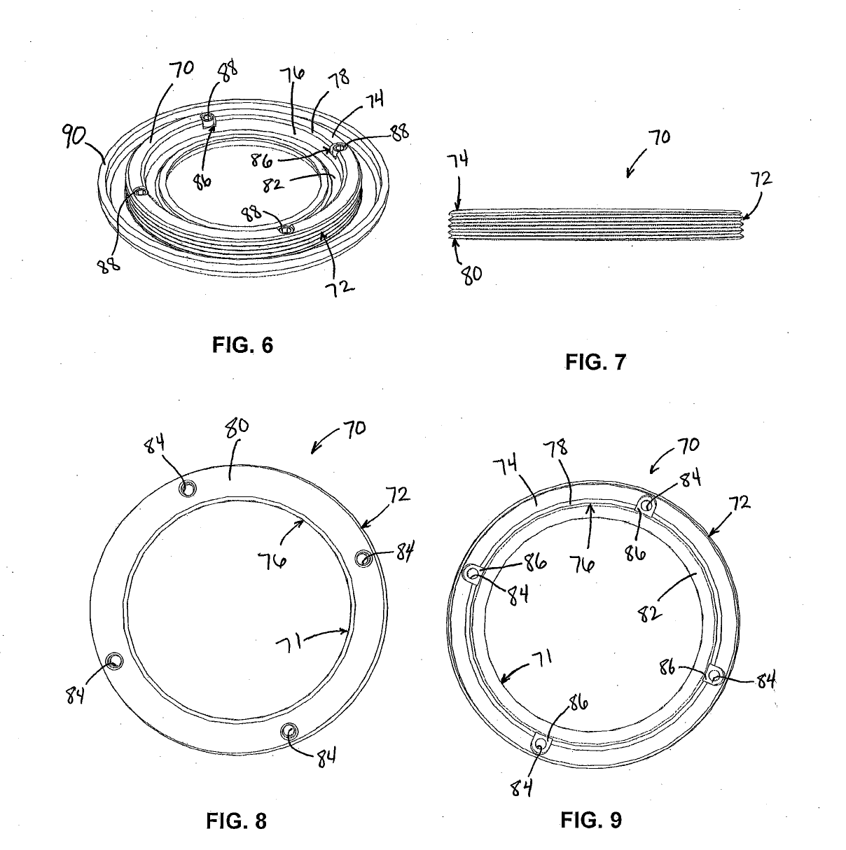

A spacer 70 engages the opening 28 in the front surface 26 of the housing 20. According to one embodiment of the invention, a portion 29 of the inner surface 31 of the side wall 24 is threaded. Referring also to FIGS. 6-9, at least a portion of the outer surface 72 of the spacer 70 has a complementary thread to rotatably engage the threaded portion 29 of the side wall 24. Optionally, the spacer 70 may engage the opening 28 by any other suitable method, including but not limited to, a friction fit, a retaining clip, or tabs configured to engage corresponding apertures. A rear surface 74 of the spacer 70 is generally planar and recessed within the second cavity 35. An inner surface 76 of the spacer 70 meets the rear surface 74 at a beveled edge 78 and extends from the beveled edge toward a lip 82 extending radially inward from the inner surface 76. An inner periphery of the lip 82 defines an opening 71 through the spacer 70 through which the light radiates.

Referring again to FIG. 2, the light fixture 10 may further include a reflector 65 contained within the second cavity 35. A rim 69 of the reflector 65 is configured to engage the rear surface of the lip 82 on the spacer 70, and an opening 67 in the reflector 65 has a diameter large enough to allow the LEDs 14 mounted on the second printed circuit board 15 to be positioned within the opening 67. The reflector 65 may be of any suitable form, including but not limited to parabolic or elliptical, to direct light emitted from the LEDs 14 through the opening 71 in the spacer 70.

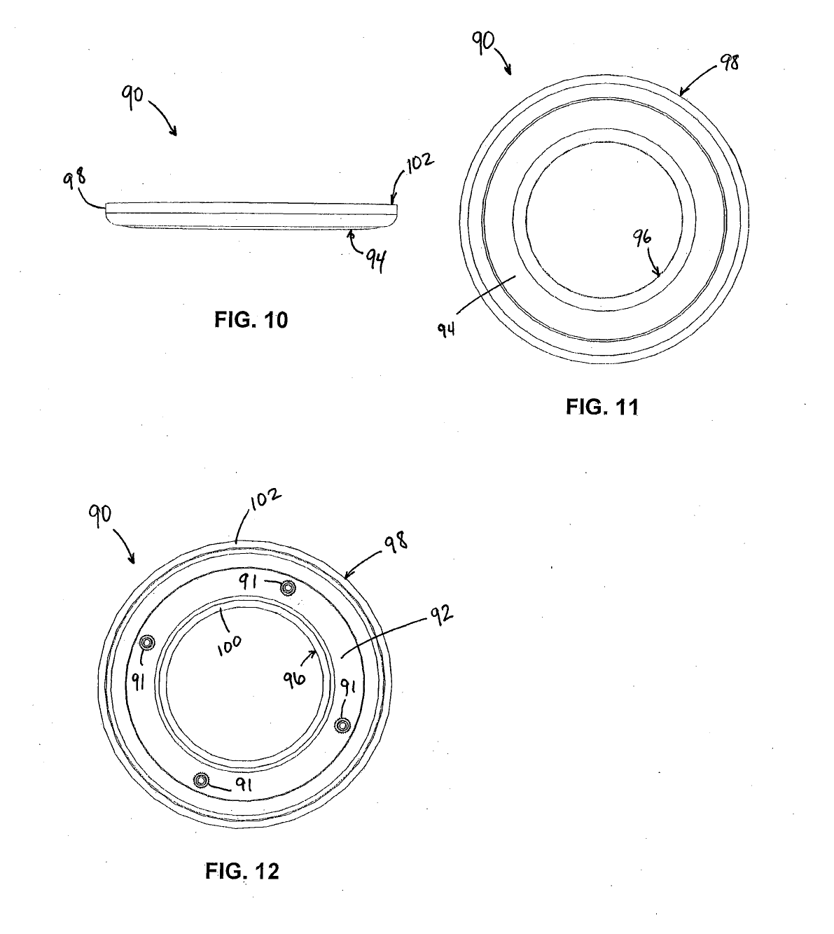

Referring also to FIGS. 6-12, a trim member 90 is connected to the spacer 70. The spacer 70 includes multiple openings 84 extending through the spacer 70. According to the illustrated embodiment, four openings 84 are equally spaced around the circumference of the spacer 70. It is contemplated that fewer or a greater number of openings 84 may be included in the spacer 70 at varying intervals without deviating from the scope of the invention. Each opening 84 preferably has a threaded interior and is in communication with a recess 86 in the rear surface 74 of the spacer 70. The recess 86 is preferably large enough to receive the head of an externally threaded fastener 88, such as a bolt, engaging each opening 84. The externally threaded fastener 88 extends through the opening 84 and engages an internally threaded fastener 91 mounted to a rear surface 92 of the trim member 90. The internally threaded fastener 91 may be, for example, a PEM® brand nut.

The trim member 90 covers the front surface 26 of the housing 20 and the spacer 70. A front wall 94 of the trim member extends generally from an inner periphery of the lip 82 on the spacer 70 to an outer periphery of the flange 30 on the housing 20. For a cylindrical housing 20, the trim member 90 is preferably ring-shaped. Optionally, the trim member may be of any suitable shape according to either the shape of the housing 20 or as desired in the application. The trim member 90 may also included an inner wall 96 and an outer wall 98. The inner wall 96 extends rearward from the front wall 94 and defines an inner periphery of the trim member 90. A rear surface 100 of the inner wall 96 may also define a seat for a lens 110. Preferably, the lens 110 is positively retained between the rear surface 100 of the inner wall 96 and a portion of the reflector 65. The outer wall 98 extends rearward from the front wall 94 and defines an outer periphery of the trim member 90.

Referring again to FIG. 2, the rigid connection between the spacer 70 and the housing 20 and between the spacer 70 and the trim member 90 maintain a spatial alignment between the housing 20 and the trim member 90. A first gap 104 is defined between the rear surface 92 of the trim member 90 and the front surfaces, 26 and 34, of the housing 20 and flange 30, respectively. A second gap 106 is defined between the inner wall 96 of the trim member 90 and the lip 82 of the spacer 70. A third gap 108 is defined between the outer wall 98 of the trim member 90 and the outer periphery of the flange 30. Thus, the spacer 70 retains the trim member 90 in alignment with the housing 20 such that the trim member 90 remains out of contact with the housing 20.

In operation, the light fixture 10 is inserted through an opening in a mounting surface 50. To insert the light fixture 10 into the mounting surface 50 the spacer 70 and trim member 90 are initially removed or left off of the light fixture 10, providing access to the threaded members 40. As the light fixture 10 is inserted through the opening, the mounting tabs 60 are initially positioned such that they are in a first position, adjacent to the side wall 24 and proximate to the rear of the housing 20. The light fixture 10 is inserted until the rear surface 32 of the flange 30 engages the front side 56 of the mounting surface 50. Once the light fixture 10 engages the front side 56 of the mounting surface 50, the threaded members 40, used to position the mounting tabs 60, are rotated. The rotation of the threaded member 40 causes the corresponding mounting tab 60 to rotate outward to a second position, such that it is generally perpendicular to the side wall 24 and towards the front of the housing 20. The threaded member 40 is rotated until the mounting tab 60 engages the rear side 54 of the mounting surface 50. The process is repeated for each threaded member 40 and mounting tab 60 such that each mounting tab 60 engages the rear side 54 of the mounting surface 50, positively retaining the light fixture 10 within the opening in the mounting surface 50.

After the light fixture 10 has been installed in the mounting surface 50, the spacer 70 and trim member 90 may be installed to cover the perimeter of the housing 20 and the opening in the mounting surface 50. If included, the reflector 65 and lens 110 may be positioned on the lip 82 of the spacer and on the rear surface 100 of the inner wall 96 of the trim member, respectively. The spacer 70 and trim member 90 assembly is rotated such that the threaded portion of the outer surface 72 of the spacer 70 engages the threaded portion 29 of the housing 20. The assembly is rotated until the spacer 70 engages an interior feature of the housing, such as the threaded member 40 which serves as a positive stop for the spacer 70. When engaged with the housing 20, the spacer 70 aligns the trim member 90 with respect to the housing 20 such that the trim member 90 remains out of contact with the housing 20.

The light fixture 10 receives commands via the network to control the light output from the light fixture 10. The commands may control, but are not limited to, intensity and color of the light emitted from the fixture 10. The commands are received by a processor mounted on the first circuit board 13 and interpreted to control other electronic devices which, for example, regulate the power flow to the LEDs 14. Operation of the power regulation devices and LEDs 14 each generate heat. The first end 45 of the heat tube 46 is positioned near the LEDs 14 to absorb heat generated by the LEDs and conducted through the rear surface 42 of the second member 25. The heat tube 46 conducts the heat to its second end 47 for subsequent radiation into the surrounding environment. The first and second members, 23 and 25, of the housing 20 are made of a thermally conductive material, such as aluminum, to conduct heat generated within the housing to the exterior of the housing 20. The spacer 70 is made of a thermally insulative material, such as nylon, and the spacer 70 and air gaps, 102-106, established between the housing 20 and the trim member 90, reduce the conduction of heat to the trim member 90. Thus, the trim member 90 which is within the passenger compartment is maintained at a lower temperature than the portion of the housing 20 recessed beyond the mounting surface 50.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention

We claim:

1. A light fixture comprising:
a housing, configured to support a light source, having a front surface with an outer periphery and an opening extending through the front surface, the opening defining an inner periphery of the front surface;
a spacer engaging the opening in the housing;
a trim member connected to the spacer and substantially covering the spacer and the front surface of the housing, wherein the spacer retains the trim member in alignment with the housing such that a gap is maintained between the trim member and the housing.

2. The light fixture of claim 1 wherein the housing further includes a side wall having an inner surface extending into the housing from the opening in the front surface, a portion of the inner surface proximate to the opening being threaded, wherein an outer surface of the spacer is complementarily threaded to engage the inner surface of the housing.

3. The light fixture of claim 2 wherein the spacer further includes a generally planar rear surface, a generally planar inner surface joined to the rear surface by a beveled edge, and a lip extending radially inward, the light fixture further comprising a reflective member having an opening in the rear portion to receive light radiated by the light source wherein the front edge of the reflective member is configured to engage the flip of the spacer.

4. The light fixture of claim 2 wherein the spacer is rigidly connected to the trim member.

5. The light fixture of claim 4 further comprising:
a plurality of internally threaded fasteners mounted to a rear surface of the trim member;
a plurality of openings extending through the spacer, each opening corresponding to one of the internally threaded fasteners; and
a plurality of externally threaded fasteners, each externally threaded fastener extending through one of the openings to operably engage one of the internally threaded fasteners and to positively retain the spacer to the trim member.

6. The light fixture of claim 4 wherein the spacer is made of a thermally insulating material.

7. The light fixture of claim 6 wherein an outer surface of the housing includes a plurality of fins configured to conduct heat from the housing.

8. The light fixture of claim 4 wherein the trim member further comprises:
a front wall;
an outer wall extending rearward from the front wall to substantially enclose an outer periphery of the flange; and
an inner wall extending rearward from the front wall toward the opening defined in the front surface of the housing.

9. The light fixture of claim 8 wherein the spacer further aligns the trim member with the housing such that a gap is maintained between the outer wall of the trim member and the outer periphery of the flange.

10. The light fixture of claim 9 further comprising a lens wherein the inner wall defines a seat for the lens.

11. A recessed light fixture comprising:
a housing configured to accept a light source, the housing further comprising
a rear wall,
at least one side wall extending from the rear wall to a front surface of the housing and defining an opening in the front surface of the housing, and
a flange extending radially outward from an outer periphery of the side wall, wherein a rear surface of the flange is configured to engage a front side of a mounting surface;
a mounting tab configured to engage a rear side of the mounting surface;
a spacer connected to the side wall and proximate to the opening in the front surface of the housing;
a trim member connected to the spacer and substantially covering the spacer and the flange, wherein the spacer aligns the trim member with respect to the housing such that a space is maintained between the trim member and the housing.

12. The recessed light fixture of claim 11 wherein the spacer is removably connected to the housing.

13. The recessed light fixture of claim 12 wherein a portion of an inner surface of the side wall proximate to the opening is threaded and an outer surface of the spacer is complementarily threaded to engage the inner surface of the side wall.

14. The recessed light fixture of claim 11 further comprising:
a plurality of internally threaded fasteners mounted to a rear surface of the trim member;
a plurality of openings extending through the spacer, each opening corresponding to one of the internally threaded fasteners; and
a plurality of externally threaded fasteners, each externally threaded fastener extending through one of the openings to operably engage one of the internally threaded fasteners and to positively retain the spacer to the trim member.

15. The recessed light fixture of claim 14 wherein the spacer is made of a thermally insulating material.

16. The recessed light fixture of claim 15 wherein the housing is made of a thermally conductive material.

17. The recessed light fixture of claim 11 wherein the trim member further comprises:
a front wall;
an outer wall extending rearward from the front wall to substantially enclose an outer periphery of the flange; and
an inner wall extending rearward from the front wall toward the opening defined in the front surface of the housing.

18. The recessed light fixture of claim 17 wherein the spacer further aligns the trim member with the housing such that a gap is maintained between the outer wall of the trim member and the outer periphery of the flange.

19. The recessed light fixture of claim 18 further comprising a lens wherein the inner wall defines a seat for the lens.
